(19) United States
(12) Patent Application Publication
(10) Pub. No.: US 2011/0126969 A1
(43) Pub. Date: Jun. 2, 2011

(54) METHOD FOR COATING PANEL-LIKE MATERIALS AND MATERIALS COATED IN THIS MANNER

(76) Inventors: Sabine Petersen, Hemmingen (DE); Michael Kerst, Kassel (DE); Rüdiger Ernst, Detmold (DE)

(21) Appl. No.: 13/020,911

(22) Filed: Feb. 4, 2011

Related U.S. Application Data
(62) Division of application No. 11/631,051, filed on Dec. 28, 2006.

(30) Foreign Application Priority Data
Jun. 30, 2004 (DE) DE 102004031963.4

(51) Int. Cl. B05D 5/10; B05D 1/36; B44C 1/16

(52) U.S. Cl. 156/230; 427/207.1; 427/202

(57) ABSTRACT

The invention relates to a method for producing decorative coatings on the surface of panel-like material pieces, during which an adhesive or coating compound is applied to the panel-like material pieces (2), whereby filler particles (4) are embedded in this compound, optionally followed by a subsequent treatment of the coatings produced in this manner. The panel-like materials provided with a decorative coating in the aforementioned manner are for use, in particular, as floor coverings, floor panels, wall or façade elements or as furniture elements.

### CROSS REFERENCES TO RELATED APPLICATIONS

This application is a Divisional application of U.S. application Ser. No. 11/631,051, filed Dec. 28, 2006, which was the National Stage filing of International Application PCT/EP2005/006125, filed Jun. 8, 2005, claiming priority to German Application No. 10 2004 031 963.4, filed Jun. 30, 2004, entitled “METHOD FOR COATING PANEL-LIKE MATERIALS AND MATERIALS COATED IN THIS MANNER”. The subject application claims the foreign priority benefit of PCT/EP2005/006125 and of German Application No. 10 2004 031 963.4 and all priority references are hereby incorporated by reference, in their entirety.

### BACKGROUND OF THE INVENTION

The present invention pertains to a method for producing, in particular, decorative coatings on panel-like material pieces or elements and to panel-like material pieces or elements coated in this fashion, as well as to their utilization, particularly in the fields of floor coverings, floor plates, wall or cladding panels, furniture elements and the like.

According to the current state of the art, elements or materials for the above-described applications are manufactured by bonding flat substrates such as, e.g., plates of stone, glass panes and plastic panels or films, laminates and genuine wood in the form of veneers, etc., on a carrier panel. Depending on the respective requirements, the bonding on the finished product is realized with various adhesive systems by means of hot-bonding or cold-bonding methods. The production is relatively costly and time-consuming, and the final products obtained with these methods not always fulfill the applicable requirements.

Consequently, the present invention is based on the objective of making available a method for cost-efficiently providing flat or panel-like workpieces or elements with a coating that fulfills the applicable requirements, particularly in the fields of floor coverings, floor plates, wall or cladding panels, furniture elements and the like.

Another objective of the present invention consists of making available panel-like materials or elements that are provided, in particular, with decorative coatings and are suitable particularly for use in the fields of floor coverings, floor panels, wall or cladding panels, furniture elements and the like.

The object of the present invention, according to a first aspect thereof, consequently is a method for producing decorative coatings on the surface of panel-like material pieces, in which the panel-like material pieces can be provided with an adhesive or coating compound, in which filler particles are embedded. If so required, the coatings produced in this manner may then be subjected to a subsequent treatment.

According to the invention, the term filler particles refers to individual particles as well as particles that consist of several coherent individual particles (e.g., filler grains that are composed of granulated, pelletized, agglomerated or similar individual particles).

For example, the filler particles used may consist of inorganic or organic filler particles, preferably inorganic powders, grains, granulates, pellets, agglomerates, compacted shaped particles or grits. The pourability or flowability of the filler particles used is of decisive importance for the processability in the inventive method.

According to the invention, the terms granulates and agglomerates generally refer to molded aggregates that have an asymmetrical or irregular geometrical shape and consist of a plurality of individual particles, wherein granulates and agglomerates can be distinguished, in particular, by the different aggregation stability of their individual particles. According to the invention, the term pellets generally refers to agglomerates of individual particles that have symmetrical or regular geometrical shapes. In the context of the invention, the term grit generally refers to comminuted stones or other mineral materials. Detailed information on the aforementioned terms can be found in relevant technical and scientific reference books and encyclopedias, e.g., in Römpp, Chemical Dictionary, 10th Edition, Georg Thieme Publishing House, Stuttgart/New York, 1999.

The fillers to be embedded are preferably selected from the group of the mineral materials, stones, construction waste, glass, plastics, recycling materials (recyclates) and mixtures thereof.

The grain sizes of the filler particles can vary in broad ranges. It is advantageous to utilize grain sizes of about 0.0001 to 5 mm, particularly 0.001 to 4 mm, preferably 0.001 to 3 mm, particularly preferably 0.01 to 2.5 mm.

In order to achieve a certain decorative effect and to realize the incorporating or embedding of the filler particles in the adhesive compound or coating compound, the filler particles are generally used in quantities of 1 to 75 wt %, particularly 10 to 75 wt %, preferably 15 to 70 wt %, particularly preferably 30 to 70 wt %, relative to the adhesive or coating compound.

The thickness of the coating as such (i.e., the adhesive or coating compound with filler particles embedded therein) can also vary in broad ranges. Depending on the intended use of the coated material pieces, the coating is generally applied with a thickness between 0.001 and 100 mm, particularly 0.01 and 10 mm, preferably 0.1 to 5 mm, especially preferably 1 to 4 mm. For example, if the panel-like materials coated in accordance with the invention are used as floor plates or floor coverings, it is common practice to apply the coatings with a thickness between approximately 2 mm and approximately 4 mm on panel-like materials that have a thickness of approximately 6 mm to approximately 10 mm.

The adhesive or coating compound as such could consist of any customary adhesive or coating compound suitable for the inventive method, particularly with respect to their compatibility with the panel-like material to be coated and the filler particles to be embedded, as well as with respect to an adequate adhesion and coating capacity. Organically based adhesives, binders or other bonding agents may be used, in particular, as adhesive or coating compound, for example, dispersion adhesives (e.g., dispersion adhesives based on polyvinyl acetates (PVAC), (meth-) acrylates or chemically cross-linking polyurethanes) or thermoplastic adhesives or hot-melts (e.g., hot-melt adhesives based on reactive polyurethanes or polyolefins).

After its application, the coating can be advantageously subjected to a drying and/or hardening and/or cross-linking process. This is preferably carried out before an optionally required subsequent treatment of the coating.

A variety of materials can be used as panel-like material pieces in the method according to the invention as long as they are suitable for use in the inventive method, particularly with respect to their compatibility with the other materials or substances. Examples of materials that are suitable for use as panel-like material pieces or material elements in the method according to the invention are—depending on the intended use of the coated and finished material pieces—wood panels, plastic sheets, plates of stone or glass panes, particularly wood panels or plastic sheets, for example, wood panels in the form of particle boards, fiber boards or massive boards (e.g., if subsequently used as floor coverings or floor plates, respectively).

As mentioned above, a subsequent treatment of the material surface coated in accordance with the inventive method may be carried out after the coating is applied and, if so required, after allowing the coating to dry, harden, cross-link or the like. The subsequent treatment of the coated material surface may consist, in particular, of mechanical and/or chemical methods, for example, grinding, brushing, smoothing, embossing, antiquing, waxing, oiling, varnishing, polishing, sealing or several of these methods in arbitrary sequence and combination.

Different embodiments of the inventive method can be utilized for the application of the coating as such.

### BRIEF SUMMARY

The invention relates to a method for producing decorative coatings on the surface of panel-like material pieces, during which an adhesive or coating compound is applied to the panel-like material pieces, whereby filler particles are embedded in this compound, optionally followed by a subsequent treatment of the coatings produced in this manner. The panel-like materials provided with a decorative coating in the aforementioned manner are for use, in particular, as floor coverings, floor panels, wall or façade elements or as furniture elements.

One object of the disclosure is to describe an improved method for producing decorative coatings on the surface of panel-like material pieces.

### BRIEF DESCRIPTION OF THE SEVERAL VIEWS OF THE DRAWINGS

FIG. 1 is a schematic illustration of the process sequence for producing the surface of the panel-like materials of the present disclosure.

FIG. 2 is a sectional illustration of the panel-like material piece coated in accordance with the present disclosure of FIG. 1.

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

According to a first embodiment of the inventive method, the coating is produced by initially applying the adhesive or coating compound to the surface(s) of the panel-like material pieces to be coated and subsequently applying, particularly scattering, the filler particles in or on the coating compound, whereafter the adhesive [sic] particles are then further incorporated into the adhesive or coating compound, particularly by pressing or forcing the particles into the respective compound.

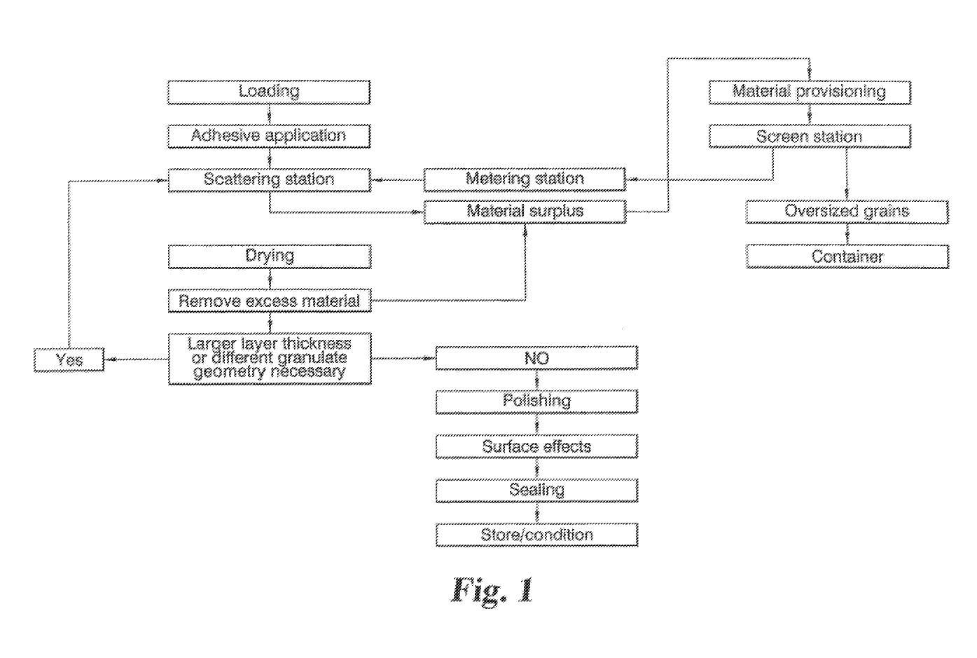

A typical process sequence of this first embodiment of the inventive method may be carried out, for example, as described below with reference to a special variation that is schematically illustrated in FIG. 1.

In this case, the surface of the panel-like materials, particularly particle boards, fiber boards or massive boards or sheet materials made of plastics, recycling materials (recyclates) or composites (composite materials), is produced by applying a suitable adhesive compound or coating compound (“binder)” to the surface of the panel-like material pieces and embedding pourable filler particles (grains, granulates, pellets, agglomerates, grits, etc.) therein. The filler particles may consist, for example, of granulates, e.g. of mineral materials, glass, plastics, recycling materials (recyclates) of all sorts, as well as other materials that are not specifically mentioned and can, if so required, be processed into pourable particles with corresponding processing methods. The pourable filler particles are then embedded in an adhesive layer (e.g., dispersion adhesive based on PVAC or acrylates or chemically cross-linking polyurethane dispersions or thermoplastic adhesives or hot-melt adhesives based on reactive polyolefins or polyurethanes). This process can be repeated several times depending on the surface requirements. In this case, it is possible to utilize different granulate geometries or even materials of different granulate types in order to achieve certain effects. The finished decorative surfaces or coatings can—depending on the respective requirements for the optical appearance and the technical properties of the finished product—subjected to additional processing steps such as smoothing, embossing, grinding, brushing, antiquing, waxing, oiling, varnishing and/or polishing after the individual subsequent treatments, in arbitrary sequences and combinations.

The processing sequence according to this first embodiment of the inventive method can be typically carried out as described below (see FIG. 1).

The panel-like material pieces are delivered to a first machine for applying adhesive with the aid of corresponding feed devices. The carrier material is pneumatically or mechanically cleaned before the adhesive is applied. The surface of the panel-like material may be pre-heated upstream of the inlet into the machine for applying adhesive on the surface, if so required, by subjecting the surface to heat energy, e.g., with the aid of hot-air blowers, IR radiators or comparable energy sources, so as to improve the wetting of said surface. Depending on the type of adhesive used can be applied by means of spraying with a surface spraying machine, as well as with roller-type application devices or doctor blades and nozzles. Depending on the requirements with respect to the finished product and the system configuration, the described machine types can be arbitrarily combined with one another in a system. After the adhesive is applied, the panel-like material is delivered to a scattering station, in which the pourable granulate is applied on the carrier panel wetted with adhesive by means of scattering units (air scattering, gravity scattering, roller-type separators or vibrating chutes, respectively, screens with eccentric drives or blasting jets, etc.). If so required, a downstream pressing device, e.g., a pressing roller or imprinting roller, may be used for embedding the granulate deeper into the adhesive layer. The scattering station can be supplied by a reservoir (silo, push floor system, “vibrotable,” etc.) with a discharge device and a downstream screening station, or directly from commercially available receptacles such as, so-called “Big Bags.” The adhesive is dried downstream of the scattering station. If the drying process does not take place automatically due to chemically reacting adhesives or physically curing adhesives such as, for example, hot-melt systems (recrystallization) or solvent adhesives (diffusion), suitable drying methods are used for water-based adhesive systems, e.g., microwave drying, high-frequency drying, ultrasonic drying, cold drying, flat section or vertical drying (i.e., combinations of evaporation zones, air circulation dryers, jet dryers and IR dryers), with UV drying and electron beam hardening being used for adhesive systems with 100% solids content. After the surface has dried, excess material is pneumatically and/or mechanically removed and returned to the granulate reservoir. Depending on the requirements with respect to the final product or the desire layer thickness or layer structure, respectively, the adhesive application and the scattering process can be repeated as many times as necessary, namely with all sorts of granulate types and geometries. Once the granulate quantities required for the respective final product has been applied, an intermediate or final grinding or brushing of the surface can be carried out by means of automatic grinding and brushing machines. The surface can be additionally treated or finished in order to achieve certain effects, by means of corresponding technical systems such as, e.g., distribution machines for smoothing, antiquing, oiling and waxing surfaces or imprinting rollers or imprinting dies for realizing certain surface structures. In addition, structured surfaces can be produced with special spraying techniques and varnishing systems during the application of the binder. Special surface effects can also be realized by laminating structured carrier materials such as, e.g., papers, nonwoven fabrics, textile fabrics, etc. onto the adhesive. Additional intermediate grinding processes may be carried out—if so required—before the final treatment. The granulate surface can be sealed—if so required—with oils, waxes, sealing compounds, varnishes and paints or any combinations of the cited materials. Any sealing process requires specific processing steps that require no detailed explanation because a person skilled in the art is sufficiently familiar with these steps.

According to a second alternative embodiment of the inventive method, the coatings are produced by initially pre-mixing the adhesive or coating compound with the filler particles to be embedded therein, wherein the thusly obtained mixture of the adhesive or coating compound and the filler particles is applied on a suitable carrier, the side of the carrier containing the mixture of the adhesive or coating compound and the filler particles is laminated onto the surface(s) of the panel-like material pieces to be coated and the carrier is subsequently removed, if so required.

This second alternative embodiment of the inventive method may be carried out, for example, as described below: in this embodiment, the application of the adhesive compound and the filler particles to be embedded therein is realized beforehand on a suitable carrier material, particularly papers, nonwoven fabrics and thin panel-like materials. This pre-coated carrier material can then be laminated onto the actual carrier panel in an ensuing processing step, by means of hot-pressing or cold-pressing methods.

According to a third alternative embodiment of the inventive method, the coatings are produced by initially pre-mixing the adhesive or coating compound with the filler particles to be embedded therein and subsequently applying the resultant mixture of the adhesive or coating compound and the filler particles to the surface(s) of the panel-like material pieces to be coated.

This third alternative embodiment of the inventive method may be carried out, for example, as described below: a pourable granulate of filler particles to be embedded can be pre-mixed with a suitable binder by means of corresponding mixing devices in order to be subsequently applied to a suitable carrier material in the form of a coating compound. This carrier material may consist of the actual material panel or, in the case of a pre-coating in accordance with the second embodiment of the inventive method, of other suitable materials such as, e.g., papers, nonwoven fabrics or thin panel-like materials, etc.

Another object of the present invention, according to a second aspect thereof, consists of panel-like materials that are provided with a decorative coating in accordance with the inventive method, i.e., the coated final products available after carrying out the inventive method.

This pertains to panel-like materials that are provided with a decorative coating on at least one of their surfaces, wherein the coating comprises an adhesive or coating compound that is permanently connected to the material surface and contains the embedded filler particles.

With respect to other details of the panel-like material pieces according to the invention, we refer to the explanation of the inventive method, which applies analogously to the inventive panel-like material pieces.

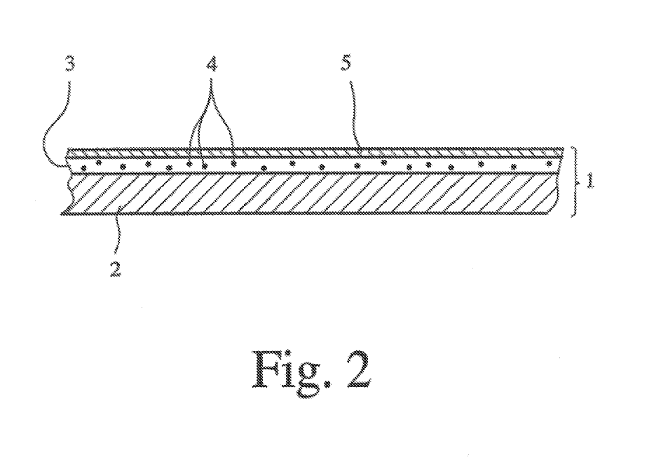

FIG. 2 shows a schematic sectional representation of a preferred embodiment of a panel-like material piece coated in accordance with the invention: the panel-like material piece 1 coated in accordance with the invention consists of the material panel 2 (e.g., wood panel or plastic sheet), on which a coating according to the invention such as an adhesive or coating compound 3 with filler particles 4 embedded therein is applied. This adhesive or coating compound provides the material panel with the desired appearance (e.g., a stone-like appearance if fine stone particles or stone granulates or grits are/is used). In the embodiment shown in FIG. 2, the inventive coating consisting of the adhesive or coating compound 3 and the filler particles 4 embedded therein also undergoes a subsequent treatment, in which an upper layer or cover layer 5 is applied, for example, a sealing layer (e.g., of varnish, wax, oil, etc.) or the like.

The above-described methods according to the invention make it possible to produce workpieces, the coated surfaces of which have the optical appearance of the respective starting product (e.g., the optical appearance of natural stone if filler particles of natural stone are used) or a new optical appearance when different filler particles are used (i.e., combinations of different filler types and/or geometries).

Since waste materials and recycling materials (e.g., comminuted construction waste) can also be used as filler particles, the inventive method is advantageous with respect to environmental as well as economical aspects.

Another advantage of the inventive method can be seen in that a high throughput can also be achieved in industrial applications.

Other advantages of the inventive method can be seen in the reduction of the materials used and therefore the lower weight of the finished products. However, it is also easily possible to produce panel-like material pieces of types only known from composite materials that are difficult to bond to one another due to the frequently differing dimensional variations of the individual substrates in practical applications under the influence of heat and moisture. Surfaces of this type, in particular, with glass in the form of a pourable granulate, grit or the like applied thereon make it possible to eliminate the energy-intensive melting process for the production of glass panes.

Due to the numerous possible coatings, the panel-like material pieces coated in accordance with the invention are suitable for a variety of applications.

Another object of the present invention, according to a third aspect thereof, consequently is the utilization of panel-like materials that are provided with a decorative coating in accordance with the inventive method, i.e., the utilization of the final products obtained with the inventive method, particularly in the fields of floor coverings, wall or cladding panels (i.e., in construction) and in the furniture industry, especially the utilization as floor coverings, floor plates, wall or cladding elements or furniture elements.

For example, the panel-like materials provided with a decorative coating in accordance with the inventive method can be utilized in the interior of buildings, the construction of stores and exhibition booths (e.g., as a partition wall or presentation surface), in conventional interior finishing (e.g., as a wall or ceiling panel element) and as wall elements (e.g., as partition walls in interiors). In addition, panel-like material pieces coated in accordance with the inventive method can also be used as floor elements or floor coverings. For example, the incorporation or embedding of mineral filler particles such as stone grit, provides floor plates with a stone-like surface feel and optical appearance while simultaneously reducing the costs in comparison to pure stone (e.g., granite). In addition, the panel-like material pieces coated in accordance with the inventive method can be utilized in the furniture industry, e.g., as outside surfaces, work surfaces or in the construction of complete furniture. Panel-like material pieces coated in accordance with the inventive method are used outdoors in the form of panels, particularly cladding panels.

Upon reading through this description, a person skilled in the art would be easily able to conceive and realize other embodiments, modifications and variations without deviating from the scope of the present invention.

While the preferred embodiment of the invention has been illustrated and described in the drawings and foregoing description, the same is to be considered as illustrative and not restrictive in character, it being understood that all changes and modifications that come within the spirit of the invention are desired to be protected.

1. A method for producing a decorative coating on the surface of a panel-like material piece for floor coverings, floor plates, wall or cladding elements and furniture elements, characterized by the fact that wood panels, plastic sheets, plates of stone or glass panes are used as panel-like material pieces, comprising the following steps:
providing a panel-like material piece;
applying an adhesive or coating compound that contains embedded filler particles with a thickness of 0.01 to 100 mm to said panel-like material piece, wherein said filler particles consist of inorganic or organic powders, grains, granulates, pellets, agglomerates, compacted shaped particles or grits that have a grain size of 0.01 to 4 mm and are used in amounts of 10 to 75 wt % relative to the adhesive or coating compound; and
subjecting the resultant coating to a subsequent treatment by means of mechanical and/or chemical treatment methods.

2. The method according to claim 1, characterized by the fact that the filler particles consist of materials that are selected from the group of mineral materials: stones, construction waste, glass, plastics, recycling materials (recyclates) and mixtures thereof.

3. The method according to claim 2, characterized by the fact that the filler particles are used in quantities of 15 to 70 wt %, especially preferably 30 to 70 wt % relative to the adhesive or coating compound.

4. The method according to claim 3, characterized by the fact that the coating is applied with a thickness of 0.01 to 10 mm, preferably 0.1 to 5 mm, particularly preferably 1 to 4 mm.

5. The method according to claim 4, characterized by the fact that organically based adhesives, binders or other adhesive mediums are used as adhesive or coating compound, particularly dispersion adhesives such as dispersion adhesives based on polyvinyl acetates (PVAC), (meth-) acrylates or chemically cross-linking polyurethanes or thermoplastic adhesives (hot-melts), such as thermoplastic adhesives based on reactive polyurethanes or polyolefins.

6. The method according to at claim 1 including the further step of subjecting the coating to a drying and/or hardening and/or cross-linking process after its application and before an optionally required subsequent treatment.

7. The method according to claim 6, characterized by the fact that wood panels or plastic sheets are used as panel-like material pieces, preferably wood panels in the form of particle boards, fiber boards or massive wood panels.

8. The method according to claim 1, characterized by the fact that the coatings are produced by initially applying the adhesive or coating compound to the surface(s) of the panel-like material pieces to be coated and subsequently applying, particularly scattering, the filler particles in or on the coating compound, wherein the adhesive particles, if so required, are subsequently further incorporated into the adhesive or coating compound, particularly by pressing, forcing or similarly embedding the particles into the compound.

9. The method according to claim 1, characterized by the fact that the coatings are produced by first pre-mixing the adhesive or coating compound with the filler particles to be embedded therein, subsequently applying the resultant mixture of adhesive or coating compound and filler particles to a suitable carrier and ultimately laminating the coated side of the carrier containing the mixture of adhesive or coating compound and filler particles onto the surface(s) of the panel-like material pieces to be coated, wherein the carrier is subsequently removed, if so required.

10. The method according to claim 1, characterized by the fact that the coatings are produced by initially pre-mixing the adhesive or coating compound with the filler particles to be embedded therein and subsequently applying the mixture of the adhesive or coating compound and the filler particles to the surface(s) of the panel-like material pieces to be coated.

11. The method according to claim 1, characterized by the fact that the subsequent treatment of the coated material surface consists of mechanical and/or chemical treatment methods, particularly grinding, brushing, smoothing, imprinting, antiquing, waxing, oiling, varnishing, polishing, sealing or several of these methods in arbitrary sequences and combinations.

12. The method according to claim 1, characterized by the fact that the filler particles are used in quantities of 15 to 70 wt %, especially preferably 30 to 70 wt % relative to the adhesive or coating compound.

13. The method according to claim 1, characterized by the fact that the coating is applied with a thickness of 0.01 to 10 mm, preferably 0.1 to 5 mm, particularly preferably 1 to 4 mm.

14. The method according to claim 1, characterized by the fact that wood panels or plastic sheets are used as panel-like material pieces, preferably wood panels in the form of particle boards, fiber boards or massive wood panels.
